(19) United States
(12) Patent Application Publication
(10) Pub. No.: US 2010/0184380 A1
(43) Pub. Date: Jul. 22, 2010

(54) MITIGATING INTERCARRIER AND INTERSYMBOL INTERFERENCE IN ASYNCHRONOUS WIRELESS COMMUNICATIONS

(75) Inventors: Yan Zhou, San Diego, CA (US); Ravi Palanki, San Diego, CA (US); Kapil Bhattad, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/356,122

(22) Filed: Jan. 20, 2009

(51) Int. Cl. H04B 1/00; H04B 17/00

(52) U.S. Cl. 455/63.1; 455/550.1; 455/67.11; 714/758; 714/E11.002

(57) ABSTRACT

Systems and methodologies are described that facilitate mitigating intercarrier and intersymbol interference in symbol transmissions over wireless communications where transmitter and receiver may not be time synchronized. Symbol periods can be extended for transmitting symbols such that an original symbol can be transmitted with one or more duplicated symbols keeping phase continuous, blank symbols, and/or the like. In this regard, multiple receiver windows can be required to receive the symbol such that at least one window has a non-interfered symbol even though timing can be misaligned (e.g., in asynchronous communications channels). Alternatively, the receiver windows can be divided to allow similar receipt of symbols over multiple windows such that one window has a non-interfered symbol. Also, timing misalignment that leads to phase ramping in frequency is accounted for to allow proper demodulation of the symbol.

### BACKGROUND

I. Field

The following description relates generally to wireless communications, and more particularly to mitigating intercarrier and intersymbol interference in wireless communication networks.

II. Background

Wireless communication systems are widely deployed to provide various types of communication content such as, for example, voice, data, and so on. Typical wireless communication systems may be multiple-access systems capable of supporting communication with multiple users by sharing available system resources (e.g. bandwidth, transmit power, . . . ). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP long term evolution (LTE), ultra mobile broadband (UMB), and/or multi-carrier wireless specifications such as evolution data optimized (EV-DO), one or more revisions thereof, etc.

Generally, wireless multiple-access communication systems may simultaneously support communication for multiple mobile devices. Each mobile device may communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations may be established via single-input single-output (SISO) systems, multiple-input single-output (MISO) systems, multiple-input multiple-output (MIMO) systems, and so forth. In addition, mobile devices can communicate with other mobile devices (and/or base stations with other base stations) in peer-to-peer wireless network configurations.

MIMO systems commonly employ multiple (N_{T}) transmit antennas and multiple (N_{R}) receive antennas for data transmission. The antennas can relate to both base stations and mobile devices, in one example, allowing bi-directional communication between the devices on the wireless network. In addition, the devices and base stations can communicate synchronously or asynchronously. To demodulate symbols received in communication environments, receiver window sizes substantially align to symbol boundaries. In asynchronous channels, however, the receiver window and symbol boundary can be misaligned, which results in intersymbol interference at the receiver. In addition, the timing misalignment can also result in intercarrier interference (power leakage from adjacent carriers).

### SUMMARY

The following presents a simplified summary of one or more embodiments in-order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more embodiments and corresponding disclosure thereof, various aspects are described in connection with facilitating extending symbol periods for communication channels allowing multiple transmission of the symbol in the extended period. In this regard, the desired symbol can be received circularly shifted in time but without substantial interference in at least one of multiple windows mitigating the need to align windows with symbol boundaries. In one example, a given symbol can be transmitted n times, where n is an integer greater than one, over an extended symbol period keeping sinusoidal phases continuous. Due to the timing misalignment portions of the symbol are received over n+1 contiguous receiver windows. In at least n receiver windows, the symbol is received free from interference. In addition, transmitting a symbol multiple times over the extended period can increase power gains as it results in receiving more than one interference free copy of the desired symbol. In low signal to noise ratio (SNR) regime, the increased power gain can compensate for bandwidth loss due to the additional repetitions, in one example. In another example, the symbol can be transmitted in conjunction with one or more blank symbols; symbols received in two contiguous windows that comprise portions of the desired symbol can then be added to produce the desired symbol circularly shifted in time without interference. Moreover, in one example, the receiver windows can be divided such that a non-interfered symbol can be received in one window, though an interfered symbol can be received in the adjacent window. For example, the receiver window size can be reducing by half. In this case, however, the frequency resolution can be decreased by two, and the amount of data that can be conveyed per symbol is also halved.

According to related aspects, a method for mitigating intercarrier and intersymbol interference in wireless communications is provided. The method includes generating a modulation symbol and generating one or more disparate symbols. The method further includes transmitting the modulation symbol along with the one or more disparate symbols in a portion of a communications channel over a symbol period extended by a factor of a length of the modulation symbol.

Another aspect relates to a wireless communications apparatus. The wireless communications apparatus can include at least one processor configured to receive a modulated symbol for transmission and receive one or more disparate symbols that are phase-continuous with the modulated symbol. The at least one processor is further configured to transmit the modulated symbol along with the one or more phase-continuous disparate symbols in a communications channel over a symbol period extended by a factor of a length of the modulated symbol. The wireless communications apparatus also comprises a memory coupled to the at least one processor.

Yet another aspect relates to a wireless communications apparatus that facilitates mitigating intercarrier interference in wireless communications. The wireless communications apparatus can comprise means for modulating a symbol and means for generating one or more disparate symbols related to the symbol. The wireless communications apparatus can additionally include means for transmitting the modulated symbol along with the one or more disparate symbols over an extended symbol period.

Still another aspect relates to a computer program product, which can have a computer-readable medium including code for causing at least one computer to generate a modulated symbol. The computer-readable medium can also comprise code for causing the at least one computer to generate one or more disparate symbols to be phase-continuous with the modulated symbol. Moreover, the computer-readable medium can comprise code for causing the at least one computer to transmit the modulated symbol along with the one or more phase-continuous disparate symbols over an extended symbol period.

Moreover, an additional aspect relates to an apparatus. The apparatus can include a symbol specifier that modulates a symbol along with one or more related disparate symbols and a signal generator that transmits the modulated symbol along with the one or more disparate symbols over an extended symbol period.

According to a further aspect, a method that facilitates mitigating interference from symbols received in wireless communications is provided. The method can include receiving a signal comprising a symbol over a plurality of receiver windows and determining at least one of the plurality of receiver windows that received the symbol without intersymbol interference. The method can further include demodulating the symbol from the at least one receiver window to retrieve data represented by the symbol.

Another aspect relates to a wireless communications apparatus. The wireless communications apparatus can include at least one processor configured to receive a signal comprising a symbol over a plurality of receiver windows and analyze the plurality of receiver windows to determine at least one receiver window that received the symbol without intersymbol interference. The at least one processor is further configured to demodulate the symbol from the at least one receiver window to retrieve data represented by the symbol. The wireless communications apparatus also comprises a memory coupled to the at least one processor.

Yet another aspect relates to a wireless communications apparatus for mitigating intersymbol interference in communicating over asynchronous channels. The wireless communications apparatus can comprise means for receiving a signal comprising a symbol over a plurality of receiver windows and means for analyzing the plurality of receiver windows to determine at least one receiver window that received the symbol without intersymbol interference. The wireless communications apparatus can additionally include means for demodulating the symbol from the at least one receiver window to retrieve data represented by the symbol.

Still another aspect relates to a computer program product, which can have a computer-readable medium including code for causing at least one computer to receive a signal comprising a symbol over a plurality of receiver windows. The computer-readable medium can also comprise code for causing the at least one computer to determine at least one of the plurality of receiver windows that received the symbol. Moreover, the computer-readable medium can comprise code for causing the at least one computer to demodulate the symbol from the at least one receiver window to retrieve data represented by the symbol.

Moreover, an additional aspect relates to an apparatus. The apparatus can include a receiver that receives a signal comprising a symbol over a plurality of receiver windows. The apparatus can further include a receiver window evaluator that analyzes the plurality of receiver windows to determine at least one receiver window that received the symbol as well as a symbol demodulator that demodulates the symbol from the at least one receiver window to retrieve data represented by the symbol.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 is an illustration of a wireless communication system in accordance with various aspects set forth herein.

FIG. 2 is an illustration of an example communications apparatus for employment within a wireless communications environment.

FIG. 3 is an illustration of an example wireless communications system that effectuates mitigating intercarrier interference in receiving symbols.

FIG. 4 is an illustration of an example portion of bandwidth for transmitting in accordance with various aspects described herein.

FIG. 5 is an illustration of an example diagram of symbols misaligned with multiple receiver windows.

FIG. 6 is an illustration of an example diagram of a pilot structure for a portion of bandwidth in wireless communications.

FIG. 7 is an illustration of an example portion of bandwidth for transmitting a phase-continuous extended symbol.

FIG. 8 is an illustration of an example portion of bandwidth for transmitting an extended symbol comprising a symbol and a blank symbol.

FIG. 9 is an illustration of an example portion of bandwidth received over divided receiver windows.

FIG. 10 is an illustration of an example methodology that facilitates transmitting symbol variations over extended symbol periods.

FIG. 11 is an illustration of an example methodology that facilitates receiving symbols over multiple windows to mitigate intercarrier interference.

FIG. 12 is an illustration of an example mobile device that facilitates receiving symbols over multiple windows.

FIG. 13 is an illustration of an example system that transmits symbols over extended symbol periods.

FIG. 14 is an illustration of an example wireless network environment that can be employed in conjunction with the various systems and methods described herein.

FIG. 15 is an illustration of an example system that transmits symbols in wireless communications over extended symbol periods.

FIG. 16 is an illustration of an example system that receives symbols in multiple windows to facilitate mitigating intercarrier interference.

### DETAILED DESCRIPTION

Various embodiments are now described with reference to the drawings, wherein like reference numerals are used to refer to like elements throughout. In the following description, for purposes of explanation, numerous specific details are set forth in-order to provide a thorough understanding of one or more embodiments. It may be evident, however, that such embodiment(s) can be practiced without these specific details. In other instances, well-known structures and devices are shown in block diagram form in-order to facilitate describing one or more embodiments.

As used in this application, the terms “component,” “module,” “system,” and the like are intended to refer to a computer-related entity, either hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

Furthermore, various embodiments are described herein in connection with a mobile device. A mobile device can also be called a system, subscriber unit, subscriber station, mobile station, mobile, remote station, remote terminal, access terminal, user terminal, terminal, wireless communication device, user agent, user device, or user equipment (UE). A mobile device can be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem. Moreover, various embodiments are described herein in connection with a base station. A base station can be utilized for communicating with mobile device(s) and can also be referred to as an access point, Node B, evolved Node B (eNode B or eNB), base transceiver station (BTS) or some other terminology.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data.

The techniques described herein may be used for various wireless communication systems such as code division multiple access (CDMA), time division multiple access (TDMA), frequency division multiple access (FDMA), orthogonal frequency division multiple access (OFDMA), single carrier frequency domain multiplexing (SC-FDMA) and other systems. The terms “system” and “network” are often used interchangeably. A CDMA system may implement a radio technology such as Universal Terrestrial Radio Access (UTRA), CDMA2000, etc. UTRA includes Wideband-CDMA (W-CDMA) and other variants of CDMA. CDMA2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is an upcoming release that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). CDMA2000 and UMB are described in documents from an organization named “3rd Generation Partnership Project 2” (3GPP2). The techniques described herein can also be utilized in evolution data optimized (EV-DO) standards, such as 1×EV-DO revision B or other revisions, and/or the like. Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

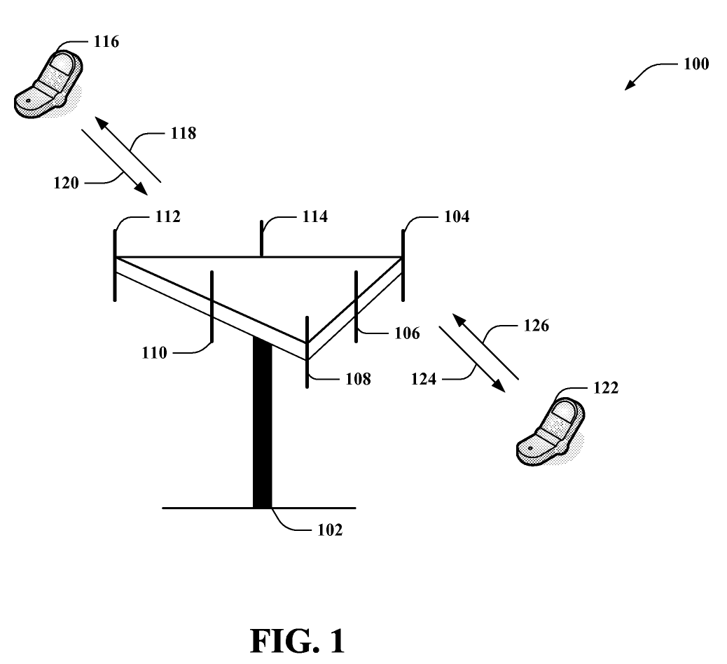

Referring now to FIG. 1, a wireless communication system 100 is illustrated in accordance with various embodiments presented herein. System 100 comprises a base station 102 that can include multiple antenna groups. For example, one antenna group can include antennas 104 and 106, another group can comprise antennas 108 and 110, and an additional group can include antennas 112 and 114. Two antennas are illustrated for each antenna group; however, more or fewer antennas can be utilized for each group. Base station 102 can additionally include a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art.

Base station 102 can communicate with one or more mobile devices such as mobile device 116 and mobile device 122; however, it is to be appreciated that base station 102 can communicate with substantially any number of mobile devices similar to mobile devices 116 and 122. Mobile devices 116 and 122 can be, for example, cellular phones, smart phones, laptops, handheld communication devices, handheld computing devices, satellite radios, global positioning systems, PDAs, and/or any other suitable device for communicating over wireless communication system 100. As depicted, mobile device 116 is in communication with antennas 112 and 114, where antennas 112 and 114 transmit information to mobile device 116 over a forward link 118 and receive information from mobile device 116 over a reverse link 120. Moreover, mobile device 122 is in communication with antennas 104 and 106, where antennas 104 and 106 transmit information to mobile device 122 over a forward link 124 and receive information from mobile device 122 over a reverse link 126. In a frequency division duplex (FDD) system, forward link 118 can utilize a different frequency band than that used by reverse link 120, and forward link 124 can employ a different frequency band than that employed by reverse link 126, for example. Further, in a time division duplex (TDD) system, forward link 118 and reverse link 120 can utilize a common frequency band and forward link 124 and reverse link 126 can utilize a common frequency band.

Each group of antennas and/or the area in which they are designated to communicate can be referred to as a sector of base station 102. For example, antenna groups can be designed to communicate to mobile devices in a sector of the areas covered by base station 102. In communication over forward links 118 and 124, the transmitting antennas of base station 102 can utilize beamforming to improve signal-to-noise ratio of forward links 118 and 124 for mobile devices 116 and 122. Also, while base station 102 utilizes beamforming to transmit to mobile devices 116 and 122 scattered randomly through an associated coverage, mobile devices in neighboring cells can be subject to less interference as compared to a base station transmitting through a single antenna to all its mobile devices. Moreover, mobile devices 116 and 122 can communicate directly with one another using a peer-to-peer or ad hoc technology as depicted.

According to an example, system 100 can be a multiple-input multiple-output (MIMO) communication system. Further, system 100 can utilize substantially any type of duplexing technique to divide communication channels (e.g. forward link, reverse link, . . . ) such as FDD, FDM, TDD, TDM, CDM, and the like. In addition, communication channels can be orthogonalized to allow simultaneous communication with multiple devices; in one example, OFDM can be utilized in this regard. The mobile devices 116 and 122 can communicate with the base station 102 over one or more subcarriers of given OFDM symbols. Subcarriers, in this context, can refer to portions of frequency carriers divided over time. A symbol (e.g., an OFDM symbol) can refer to a collection of subcarriers for a given time slot in a given frequency range. In addition, a tile can refer to a collection of adjacent subcarriers, and a tone can refer to a portion of a frequency range within a symbol. Also, a time period for single subcarriers can be referred to as chips. In one example, data to be transmitted between the mobile devices 116 and 122 and the base station 102 can be modulated into OFDM symbols using quadrature amplitude modulation (QAM), phase-shift keying (PSK), and/or the like. The OFDM symbols can be sent as signals between the mobile devices 116 and 122 and the base station 102.

According to an example, the mobile devices 116 and 122 can communicate with the base station 102 (and/or one another in a peer-to-peer configuration) synchronously or asynchronously. In one example, the channel over which the communication occurs can be utilized to determine whether the communication is to be synchronous or asynchronous. In synchronous communications, the mobile devices 116 and 122 can determine timing of the base station 102 for transmitting signals and can abide by the determined timing or vice versa. In asynchronous communications, however, the mobile devices 116 and 122 transmit signals to the base station 102 according to no particular known timing and/or vice versa. In this regard, when receiving signals, the mobile devices 116 and 122 or base station 102 do not necessarily know the boundaries of symbols sent using the signal in a given receiving time window, which can cause intercarrier and intersymbol interference, as mentioned. It is to be appreciated that the base station 102 and/or mobile devices 116 and/or 122 can determine channels that are synchronous or asynchronous—such can be indicated by one or more communicating devices, hardcoded in the device, and/or the like.

In one example, the subject matter described herein relates to mitigating such interference by extending symbol transmission time at the transmitter of the symbol. Thus, for example, the base station 102 can extend the transmission time for a given symbol allowing an extended symbol, or related data, to be received in multiple contiguous windows. In this regard, the mobile devices 116 and/or 122 receiving the extended symbol can evaluate it over at least one of the multiple windows to determine which window received the desired symbol circularly shifted in time without interference. According to one example, the base station 102 can transmit the desired symbol multiple times in the extended symbol time period keeping sinusoidal phases continuous to produce the extended symbol. Thus, the mobile devices 116 and 122 can receive the extended symbol over multiple windows where at least one of the windows provides a non-interfered view of the desired symbol, which can be circularly shifted, though another window can provide a view of a symbol with intersymbol and intercarrier interference. The non-interfered circularly shifted symbol received in the window, however, appears multiplied by a phase ramp in the frequency domain that depends on the timing misalignment. The mobile devices 116 and 122 can determine the timing misalignment based at least in part on one or more pilot signals, as described herein, by estimating and removing the phase ramp related to the non-interfered symbol for demodulation. It is to be appreciated that the symbol can be transmitted twice, in one example, doubling the transmit time. In addition, however, the symbol can be transmitted more than twice to improve power gain (e.g., sending the symbol thrice provides at least two receiver windows with a non-interfered symbol).

In another example, the base station 102 can transmit the symbol such that it is preceded and followed by a blank symbol in the extended symbol time period. In this regard, the mobile devices 116 and 122 can receive the extended symbol over multiple windows and add the received signal over all pairs of two contiguous windows to produce a stream of symbols. In this stream of symbols, the symbols that correspond to the addition of receiver windows having different portions of the desired symbols provides a view of the desired symbol circularly shifted in time but without substantial interference while the other symbols possibly have interference. Similar to the above example, the circular shift in time corresponds to a phase ramp in frequency which can be estimated and corrected using pilot signals, for example.

In yet another example, the receiver window sizes can be divided (e.g., into halves, thirds, etc.) such that the desired symbol can be received in at least one window without interference, though the others can experience interference from an adjacent symbol and/or adjacent carriers. Thus, the non-interfered symbol can be demodulated to receive transmitted data.

In addition, the base station 102 can transmit the symbols with guard bandwidth at adjacent frequencies to mitigate interference from adjacent traffic channels. It is to be appreciated that the subject matter described herein can be utilized in substantially any multicarrier-based or other symbol transmission scheme, OFDM, SC-FDMA, N×SC-FDMA (where N is an integer greater than 0), etc. whether fully or partially asynchronous.

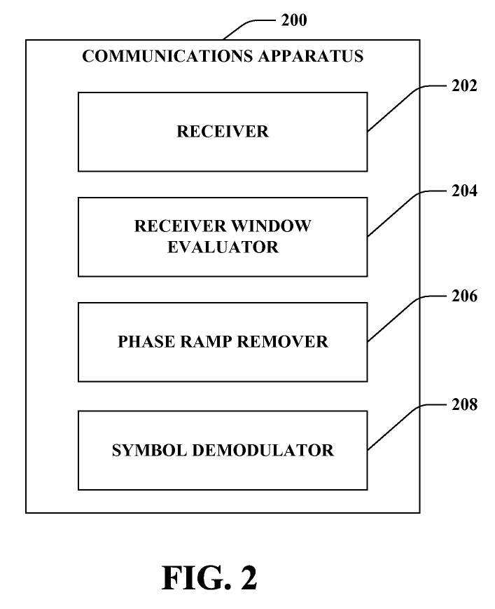

Turning to FIG. 2, illustrated is a communications apparatus 200 for employment within a wireless communications environment. The communications apparatus 200 can be a base station or a portion thereof, a mobile device or a portion thereof, or substantially any communications apparatus that receives data transmitted in a wireless communications environment. The communications apparatus 200 can include a receiver 202 that receives one or more signals transmitted from one or more devices, base stations, etc., a receiver window evaluator 204 that can implement one or more receiver windows, which can be discrete Fourier transform (DFT), fast Fourier transform (FFT), and/or similar receiver windows, for transforming the transmitted signals to one or more symbols, a phase ramp remover 206 that can remove phase ramping in the received signals, and a symbol demodulator 208 that can demodulate one or more symbols related to the signals to determine data transmitted in the signals. According to one example, the receiver 202 can receive a signal comprising a plurality of symbols, such as OFDM symbols, from one or more devices using an asynchronous communication channel. The receiver window evaluator 204 can utilize receiver windows positioned over the signals to receive portions thereof and transform the portions to one or more symbols in the window. The phase ramp remover 206 can estimate and remove phase ramp from the one or more symbols, and the symbol demodulator 208 can demodulate the symbol in a given window.

The receiver 202 can receive symbols over an extended symbol period. For example, as described, a device transmitting the symbols (not shown) can extend the period. In one example, the transmitting device can transmit the symbol twice in a phase continuous double length symbol, which can be transformed into a signal and received by the receiver 202. The receiver window evaluator 204 can evaluate the signal over three contiguous receiving DFT/FFT windows to produce three symbols. The receiver windows, for example, can be unaligned with the symbol boundaries in an asynchronous environment though the window size can be similar to the size of each symbol. This results in parts of the extended symbol being received over three contiguous receiver windows. In this regard, at least one of the three receiver windows can comprise the desired symbol, which can be circularly shifted in time without interference. The receiver window evaluator 204 can determine the window with the non-interfered desired symbol. As mentioned, the phase ramp remover 206 can estimate and correct phase ramping of the circularly shifted desired symbol, and the symbol demodulator 208 can demodulate the symbol in the window to receive data from the transmitting device. It is to be appreciated that one way of determining which window has the non-interfered desired symbol is to first demodulate the symbol, e.g., using the symbol demodulator 208, to determine which demodulation results in a valid symbol (e.g., which symbol results in the correct cyclic redundancy check (CRC)), for example.

As described, the non-interfered symbol can appear as multiplied by a phase ramp due to the timing misalignment. The phase ramp remover 206, in one example, can determine the timing misalignment based at least in part on previously received pilot signals. From the misalignment, the phase ramp can be determined by the phase ramp remover 206 and utilized to produce the symbol without the phase ramp (and hence related timing shift). At this point, the symbol demodulator 208 can demodulate the symbol. Moreover, in one example, the receiver 202 can receive more than three symbols (e.g., or N+1 symbols, where N>2) repeated phase continuously over an extended symbol period. Similarly, the receiver window evaluator 204 can analyze the received extended symbol over N+1 receiving DFT/FFT windows such that at least N−1 desired symbols circularly shifted in time can be evaluated without intercarrier or intersymbol interference. In this regard, receiving N−1 non-interfered symbols can increase gain of the related signal.

In another example, as described, the receiver 202 can receive a signal comprising a symbol transmitted over an extended symbol period along with at least one contiguous blank symbol (e.g. preceding and/or following the desired symbol). The receiver window evaluator 204 can receive portions of the extended symbols in two or more DFT/FFT windows. By adding the resulting output from the windows together, the desired symbol can be produced. In this regard, the symbol demodulator 208 can demodulate the symbol to determine which is the non-interfered desired symbol and which is the interfered symbol. In yet another example, the receiver 202 can receive a symbol over its original time period, and the receiver window evaluator 204 can divide the DFT/FFT receiver windows in two (or another multiple) such that at least one window receives a non-interfered symbol. The symbol demodulator 208 can determine the window with the non-interfered symbol and/or demodulate the symbol in that window to determine the transmitted data.

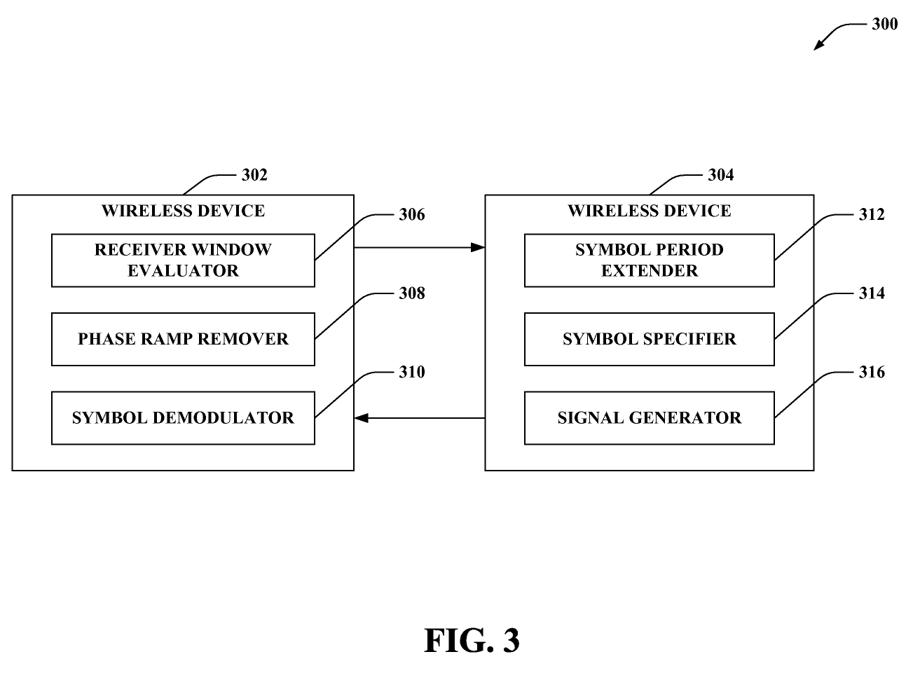

Now referring to FIG. 3, illustrated is a wireless communications system 300 that facilitates mitigating intercarrier and intersymbol interference in receiving signals transmitted thereover. Wireless device 302 and/or 304 can be a mobile device (including not only independently powered devices, but also modems, for example), a base station, and/or portion thereof In one example, wireless device 302 can transmit information to wireless device 304 over a reverse link or uplink channel; further wireless device 302 can receive information from base station 304 over a forward link or downlink channel or vice versa. Moreover, system 300 can be a MIMO system and/or can conform to one or more wireless network system specifications (e.g., EV-DO, 3GPP, 3GPP2, 3GPP LTE, etc.), and the wireless devices 302 and 304 can communicate with each other over multiple carriers using one or more symbol modulation technologies, as described. Also, the components and functionalities shown and described below in the wireless device 302 can be present in the wireless device 304 as well and vice versa, in one example; the configuration depicted excludes these components for ease of explanation.

Wireless device 302 includes a receiver window evaluator 306 that can align one or more DFT, FFT, or similar receiver windows with portions of one or more received extended signals and determine a window comprising a desired symbol without interference from other carriers or symbols, a phase ramp remover 308 that can estimate and remove phase ramp from the non-interfered received symbol, and a symbol demodulator 310 that can demodulate the resulting symbol to determine data transmitted in the signal. In one example, the receiver window evaluator 306 can align contiguous receiver windows to receive symbols transmitted with extended time periods, as described.

Wireless device 304 includes a symbol period extender 312 that lengthens a period for transmitting symbols over an asynchronous communications channel, a symbol specifier 314 that generates one or more symbols for transmitting in the extended symbol period, and a signal generator 316 that forms a signal from the one or more symbols and transmits the signal in the extended symbol period. In one example, the symbol specifier 314 can modulate data into symbols, such as OFDM symbols, for transmitting to one or more devices, and the signal generator 316 can transform the symbols into one or more signals and transmit the signals. Moreover, the signal generator 316 can encode the signals, before modulating in one example, according to an error correcting code, CRC, and/or the like.

According to an example, the wireless device 304 can communicate with the wireless device 302 over an at least partially asynchronous communication channel. The symbol period extender 312 can lengthen a symbol period required for transmitting one or more extended symbols that can comprise a desired symbol. As described, in one example, the period can be doubled or multiplied by another factor of the symbol length. Lengthening the symbol period, for example, can ensure that the wireless device 302 receives the desired symbol without interference in at least one of multiple receiver windows, as described, though the desired symbol can be circularly shifted in time. The symbol specifier 314 can produce symbols to transmit over the extended symbol period. In one example, a symbol can be modulated from data using substantially any modulation technique, including QAM, PSK, etc. The symbol specifier 314 can provide that the symbol is to be transmitted twice in the extended period (or N times, as described previously, where N>2 and the symbol period is extended enough to support the extended symbol transmission). The signal generator 316 can transform the symbols to a phase continuous extended signal. In another example, the symbol specifier 314 can provide that the symbol is to be transmitted with a blank symbol, as described and the signal generator 316 can transmit the signal to the wireless device 302.

In this example, the wireless device 302 can receive the signal, and the receiver window evaluator 306 can align multiple contiguous DFT or FFT receiver windows with the symbol to receive the extended symbol in multiple windows; the number of windows can be substantially similar to the number of symbols transmitted in the extended symbol. As described, symbols received in all but a first and last window that receive at least a portion of the symbol can be non-interfered. It is to be appreciated that the last window is typically the first window for the next symbol. Thus, mitigating intercarrier and/or intersymbol interference in receiving the symbols is achieved by utilizing the multiple windows and transmitting the symbols over an extended symbol period. Though a non-interfered symbol is received in some of the windows, it can be misaligned with the window due to the asynchrony in the communication channel between the wireless devices 302 and 304. The phase ramp remover 308 can determine a phase ramp associated with the symbol(s) based on evaluating one or more pilot signals generated and transmitted by the signal generator 316, for example, to determine a timing misalignment. Using the misalignment, the phase ramp remover 308 can compute the phase ramp and remove it from the symbols resulting in alignment with the receiver windows. Additionally, in one example, the pilot signals can be similarly specified and transmitted over extended periods.

Moreover, the signal generator 316 can transmit the phase continuous signal over a communications channel that supports synchronous and asynchronous communications, such as synchronous start technologies including code frequency division multiplexing (CFDM), and/or the like. In this example, the signal generator 316 can additionally generate synchronous signals for transmission to wireless devices with which communication timing is synchronized with the wireless device 304. The signal generator 316 can transmit the synchronous signals in some parts of the bandwidth while transmitting asynchronous signals in the remaining part using the schemes described before for the asynchronous part. In particular, the phase continuous repetition and/or adding blank symbols can be performed for the bandwidth reserved for asynchronous communication and not the bandwidth used for synchronous communication. Additionally, the signal generator 316 can implement guard bandwidth (e.g., the portion of bandwidth is unused) on either side of the communications channel that facilitates at least partial asynchronous communications to mitigate interference from other traffic channels.

In addition, due to the timing misalignment, some tones of the symbol can exhibit phase ramping. The phase ramp remover 308 can estimate the phase ramping in the tones and remove it before symbol demodulation, for example. In a given window with a non-interfered symbol, the timing misalignment can be represented as a ratio n of the timing misalignment to a chip duration, for instance. As described, a chip can be a period of time equal to the inverse of the total bandwidth comprising substantially all tones in a symbol. In this regard, the phase ramp for a k-th tone of the symbol can be represented as e^{j2πkn/M}, where j is the imaginary number \sqrt{−1}, k is the tone index, and M is the number of tones in the symbol. Using this formula, the phase ramp can be estimated, as described in further detail below, and removed. Once the timing is aligned and phase ramping removed, the symbol demodulator 310 can demodulate the symbols into data.

In another example, the symbol specifier 314 can provide a symbol for transmission in a symbol period the size of the single symbol, and the signal generator 316 can generate a signal based on the signal in the allotted time. The receiver window evaluator 306, in this example, can divide the windows in half (or another factor) such that the symbol fits in two windows. Thus, at least one of the two or more receiver windows comprises the desired symbol without interference. In a similar manner as shown above, the phase ramp remover 308 can remove phase ramp in the symbol due to timing misalignment. The symbol demodulator 310 can demodulate the non-interfered symbol to produce the data transmitted by the wireless device 304.

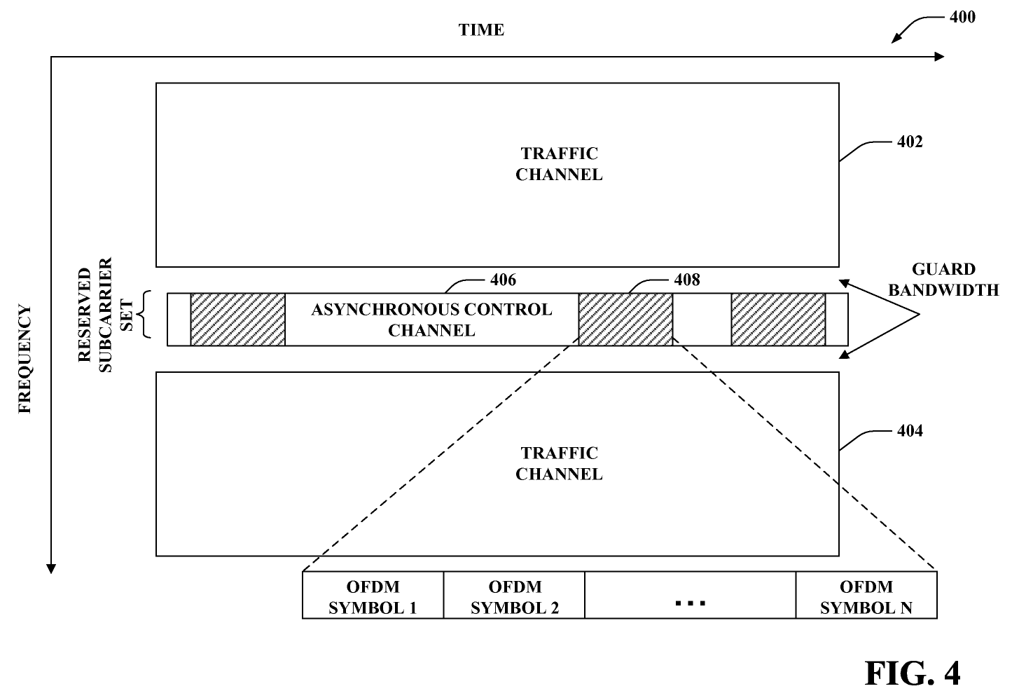

Turning now to FIG. 4, an example portion of bandwidth 400 is displayed that shows reduction of interference by utilizing guard bands, as described. The portion of bandwidth is represented as a spectrum of frequency over time. Traffic channels 402 and 404 are shown to represent one or more channels utilized to transmit data, as described above. An asynchronous control channel 406 is shown between the traffic channels 402 and 404. This channel can facilitate communication between devices without requiring time synchronization among the devices, for example. Between the asynchronous control channel 406 and the traffic channels 402 and 404 there can be guard bandwidth, as shown, to minimize interference from the traffic channels 402 and 404. Guard bandwidth can be, for example, frequency portions that are not used in transmitting signals. The guard bandwidth can vary in size to provide desired interference mitigation while balancing the loss in throughput by not using the frequency portions. The asynchronous control channel 406 shows a signal from one or more devices 408 that comprises a plurality of OFDM symbols. In one example, the symbols can be those described previously sent over an extended symbol period to mitigate intercarrier interference, as described.

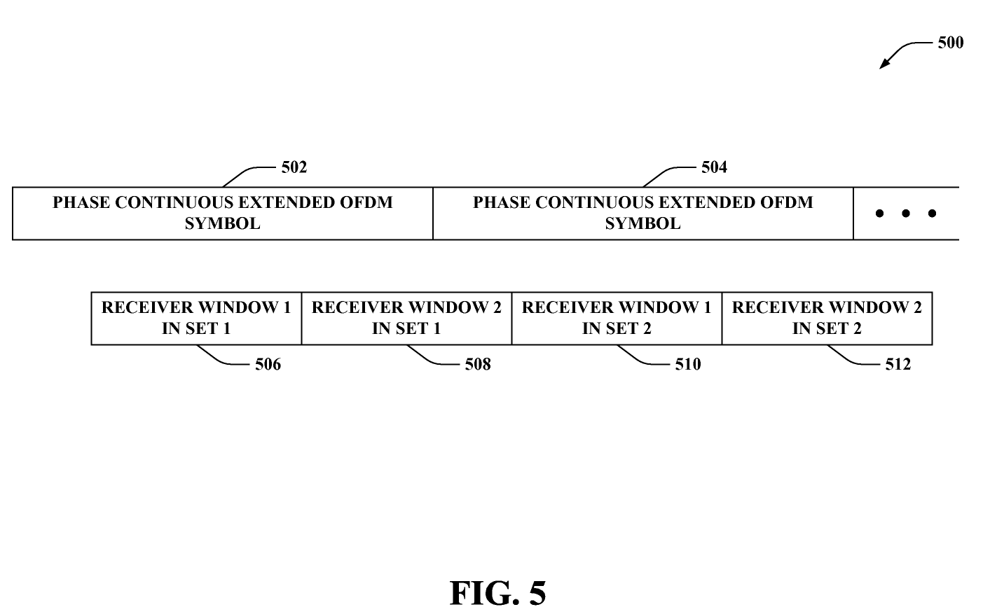

Referring to FIG. 5, an example diagram 500 of symbols and receiver windows in a time period are shown. In particular, two phase continuous extended OFDM symbols 502 and 504 are shown, which can each be transmitted in an extended time period over an asynchronous communications channel, as described herein. Additionally, receiver windows 506, 508, 510, and 512 are shown as well, which each are the same size as the original desired OFDM symbol and are grouped into sets—receiver windows 506 and 508 in set 1 and windows 510 and 512 in set 2. In this regard, though the receiver windows 506, 508, 510, and 512 are not aligned with the phase continuous extended OFDM symbols 502 and 504 (and are too small to receive the entire extended symbol), at least one window in a given set can receive a portion of each phase continuous extended OFDM symbol which is not interfered by another symbol or carrier. In the example shown, receiver window 1 in set 1 506 receives an entire non-interfered portion of phase continuous extended OFDM symbol 502, which is the desired symbol circularly shifted in time, while window 2 in set 1 508 receives the desired OFDM symbol subject to intersymbol and/or intercarrier interference. Similarly, receiver window 1 in set 2 510 receives a non-interfered OFDM symbol.

Thus, desired OFDM symbols related to phase continuous extended OFDM symbols 502 and 504, as described, can each be received without intersymbol or intercarrier interference in at least one of the windows. It is to be appreciated, as described, that the desired OFDM symbols received in the receiver windows 506 and 510 can appear misaligned. As described, the misalignment can be reversed by estimating and corrected a phase ramp associated with the misalignment. This can be accomplished, for example, based on received pilot signals, as described previously. After removing the phase ramp, the symbol received in receiver window 1 in set 1 506 can be demodulated to produce the data comprised in the desired OFDM symbol transmitted in the phase continuous extended OFDM symbol 502 as described herein, and similarly the symbol received in receiver window 1 in set 2 510 can be demodulated to produce the data comprised in the desired OFDM symbol transmitted in the phase continuous extended OFDM symbol 504.

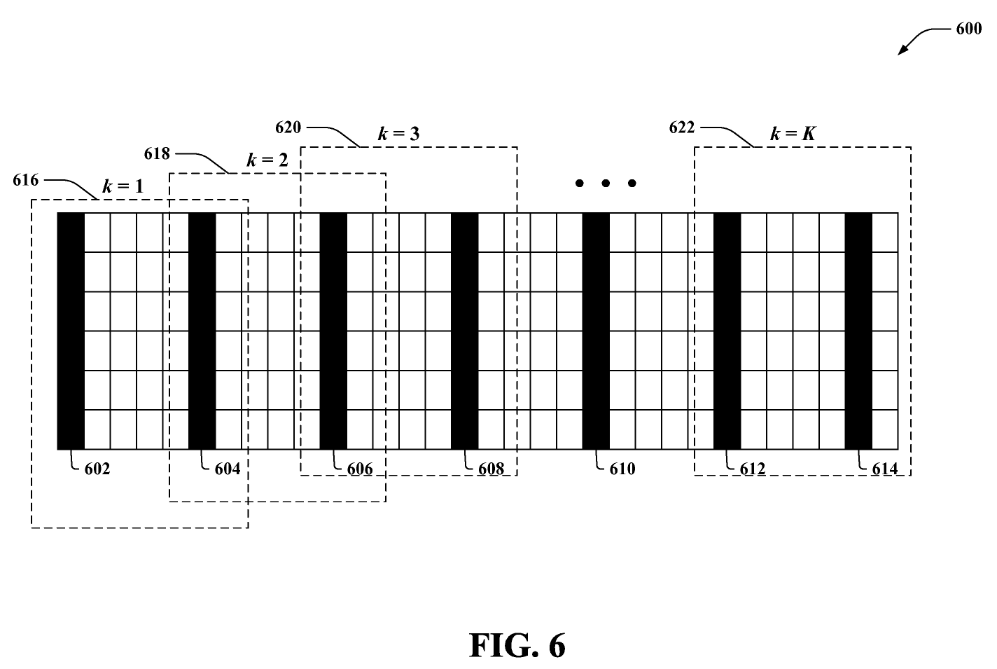

Turning now to FIG. 6, an example diagram 600 of a plurality of symbols is shown. Symbols 602-614, can represent pilot signals transmitted over the bandwidth comprising contiguous tones, as described, which can additionally be transmitted over an extended symbol period using the aspects described herein. Thus, at the receiver (not shown), one or more receiver windows can comprise a non-interfered pilot signal. The pilot signals 602-614 can be divided into K groups to facilitate estimating phase ramping. In the example shown, each group can comprise two pilot signals; however, it is to be appreciated that a group can similarly comprise one or more pilot signals. As shown, the pilot signals are grouped such that group k=1 616 comprises adjacent pilot signals 602 and 604, group k=2 618 comprises adjacent pilot signals 604 and 606, group k=3 620 comprises adjacent pilot signals 606 and 608, and so on up to group k=K 622, which comprises adjacent pilot signals 612 and 614. For each group, 616-622, a correlation between a received pilot vector and a pilot vector with an assumed phase ramp of m-chip time misalignment can be computed. The correlation can be averaged across at least a portion of the groups 616-622. Accordingly, the m representing the maximum correlation can be chosen as the estimated time misalignment, which can be utilized to undo the misalignment.

In one example, the following formula can be utilized to estimate the phase ramp.

$$\hat{n} = arg {max}_{0 \leq m \leq M - 1} \frac{1}{K} {\sum }_{k = 1}^{K} {\vert {u}_{k}^{H} {s}_{k} ( m ) \vert}^{2}$$

where M is the number of tones in a symbol, K is number of pilot groups, uₖ^{H} is the Hermitian representation of the vector that represents the pilot signals received in each group k, and the vector sₖ(m) comprises the pilot signal(s) transmitted within group k and multiplied by a phase ramp corresponding to timing misalignment of m chips. In another example, the phase ramps can be estimated by using a maximum likelihood estimator, which can select phase ramps corresponding to the time misalignment of m chips that maximizes.

$$\hat{n} = arg {max}_{0 \leq m \leq M - 1} ln p ( v \vert m )$$

where M is the number of tones in a symbol, and the vector v includes the signals received on all pilot symbols. Once estimated, the phase ramps across different tones can be removed from a symbol, and the symbol can be demodulated to produce the resulting data. In addition, the pilot signals can be utilized for channel estimation, which can be required for demodulation of data, for example.

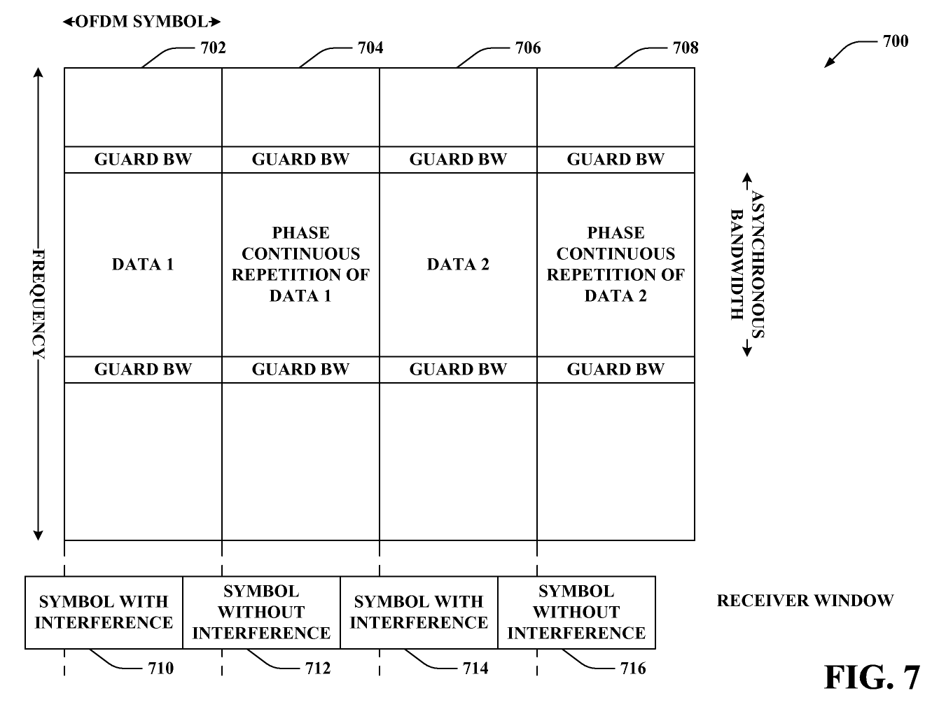

Turning to FIG. 7, an example bandwidth 700 for transmitting phase-continuous extended symbols is illustrated. The bandwidth 700 includes multiple OFDM symbols 702-708 transmitted over a span of time and frequency, as described herein. Furthermore, receiver windows 710-716 are provided for receiving the extended symbols. Each OFDM symbol 702-708, as depicted, can have data sandwiched between guard bandwidth to mitigate intercarrier interference, as described. OFDM symbol 702 comprises data 1, OFDM symbol 704 comprises a phase continuous repetition of data 1, OFDM symbol 706 comprises data 2, and OFDM symbol 708 comprises a phase continuous repetition of data 2. In this regard, OFDM symbols 702 and 704, and likewise OFDM symbols 706 and 708, can be a single extended phase continuous symbol.

As shown, the receiver windows 710-716 are substantially the same size as the OFDM symbols 702-708, and can be utilized to receive the symbols, though the windows are offset from the symbols. In this example, receiver window 710 receives the extended OFDM symbol of phase continuous symbols 702 and 704 comprising data 1 with interference from a previous symbol (not shown). However, receiver window 712 receives the symbol without interference from adjacent symbols, though the symbol can be circularly shifted in time. Similarly, receiver window 714 receives the extended OFDM symbol of phase continuous symbols 706 and 708 comprising data 2 with interference from OFDM symbol 704. Receiver window 716, however, receives the symbol without interference from adjacent symbols. Phase ramps across the tones for the symbols in receiver windows 712 and 716 due to the time misalignment can be estimated and removed. Subsequently, the symbols can be demodulated, as described herein.

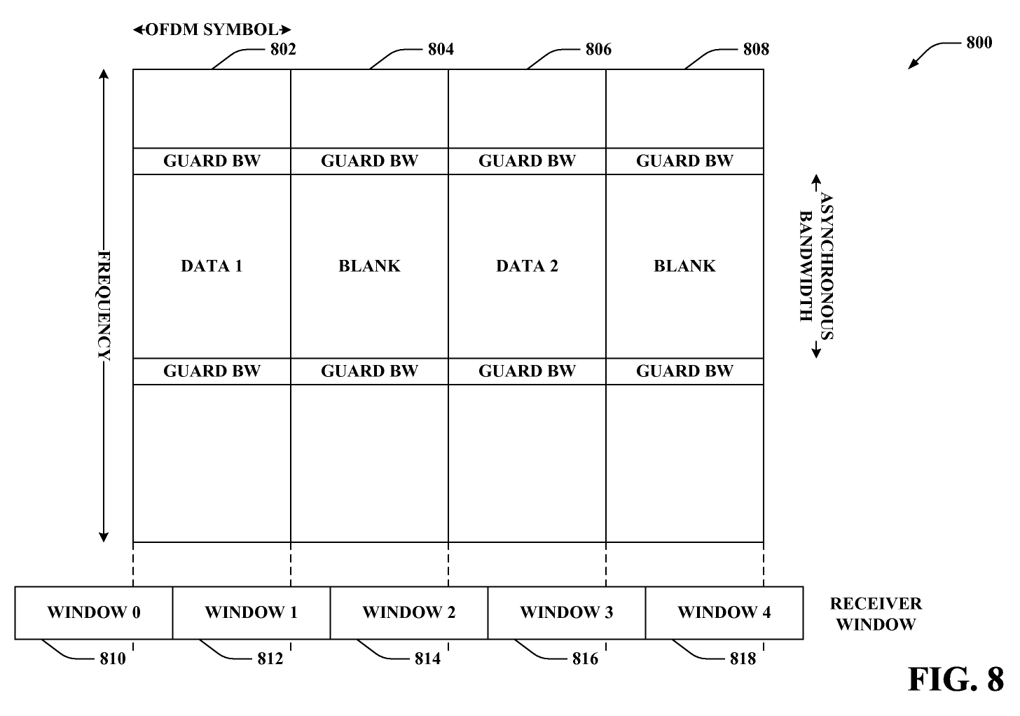

Referring now to FIG. 8, illustrated is an example bandwidth 800 for transmitting symbols with blank symbol. The bandwidth 800 includes multiple OFDM symbols 802-808 transmitted over a span of time and frequency, as described herein. Furthermore, receiver windows 810-818 are provided for receiving the extended symbols. Each OFDM symbol 802-808, as depicted, can have data sandwiched between guard bandwidth to mitigate intercarrier interference, as described. OFDM symbol 802 comprises data 1, OFDM symbol 804 comprises a blank symbol, OFDM symbol 806 comprises data 2, and OFDM symbol 808 comprises a blank symbol.

As shown, the receiver windows 810-818 are substantially the same size as the OFDM symbols 802-808, and can be utilized to receive the symbols, though the windows are offset from the symbols. In this example, receiver windows 810 and 812 receive data 1 without interference since the receiver window 810 can have received a blank symbol (not shown) and a portion of the OFDM symbol 802, and receiver window 812 receives the other portion of OFDM symbol 802 and a portion of blank symbol 804. Adding the resulting windows, the desired symbol can be produced, though the symbol can be circularly shifted in time. Again, this can be cured by estimating and removing the phase ramp. Similarly, receiver windows 814 and 816 receive the OFDM symbol 806 comprising data 2 along with blank symbols on either side. Thus, the receiver windows 814 and 816 can be added to produce the shifted desired OFDM symbol.

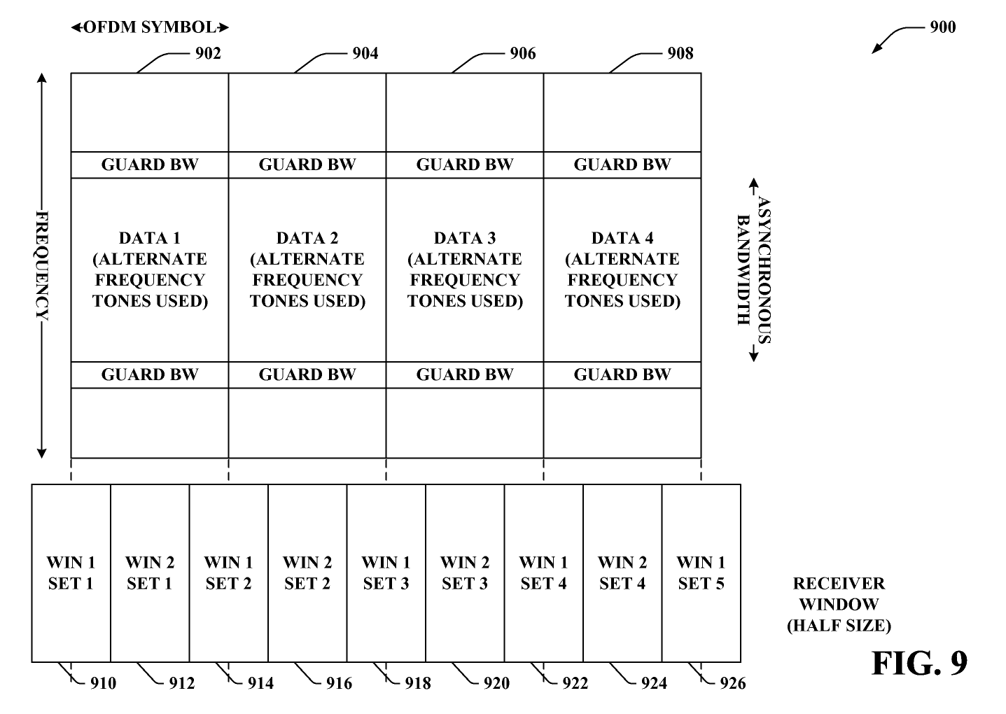

Now turning to FIG. 9, an example bandwidth 900 that is received in divided receiver windows is illustrated. The bandwidth 900 includes multiple OFDM symbols 902-908 transmitted over a span of time and frequency, as described herein. Furthermore, receiver windows can be divided into sets of receiver windows each set having two windows. Thus, receiver windows 910-926 are provided for receiving the OFDM symbols 902-908. Each OFDM symbol 902-908, as depicted, can have data sandwiched between guard bandwidth to mitigate intercarrier interference, as described. OFDM symbols 902-908 can comprise distinct data and use alternate frequency tones to convey the data.

As shown, the receiver windows 910-926 are substantially half the size as the OFDM symbols 902-908, and can be utilized to receive the symbols, though the windows are offset from the symbols. In this example, receiver window 912 receives the OFDM symbol 902 without interference from adjacent symbols, while receiver windows 910 and 914 receive the OFDM symbol 902 with interference from neighboring symbols. The OFDM symbol 902, as received in receiver window 912 however, can be circularly shifted in time. This can be cured, as described, by estimating and removing a phase ramp related to the shift. Similarly, receiver window 916 receives the OFDM symbol 904 without interference from adjacent symbols, receiver window 920 receives the OFDM symbol 906 without interference from adjacent symbols, and receiver window 924 receives the OFDM symbol 908 without interference from adjacent symbols. The remaining receiver windows 918, 922, and 926 receive symbols with interference. Once phase ramp is removed, for example, the OFDM symbols 902-908 respectively received in receiver windows 912, 916, 920, and 924 can be demodulated, as described herein.

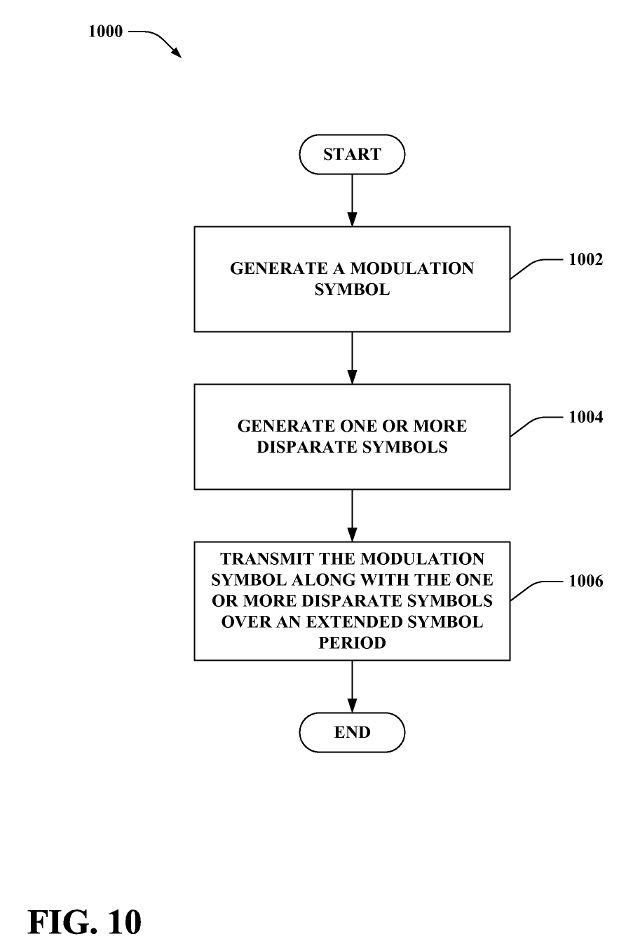

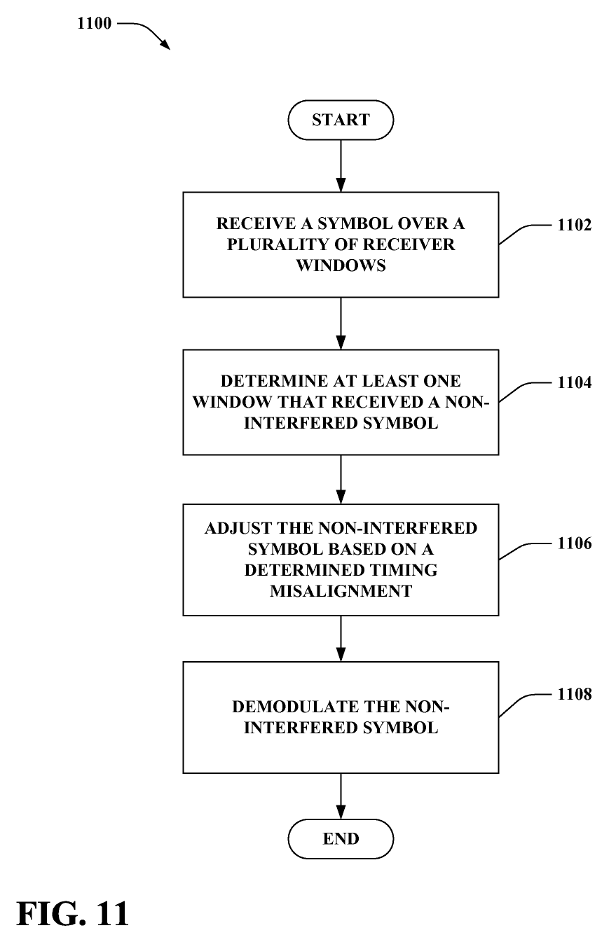

Referring to FIGS. 10-11, methodologies relating to mitigating intercarrier and intersymbol interference in receiving symbol transmissions over wireless communication networks are illustrated. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more embodiments.

Turning to FIG. 10, a methodology 1000 that facilitates transmitting symbols in wireless communications that can be received without interference is displayed. At 1002, a modulation symbol can be generated. This can be a symbol representing data to be transmitted over a communication channel, as described. At 1004, one or more disparate symbol(s) can be generated. The disparate symbol(s) can be related to the modulation symbol. For example, the disparate symbols, as described, can be phase-continuous duplicates of the modulated symbol, blank symbols, etc. At 1006, the modulation symbol can be transmitted along with the disparate symbol(s) over an extended symbol period. For example, as described, the symbol period can be extended by a factor of the length of the modulated symbol such that the symbol can be transmitted with the disparate symbol(s) over the period. In one example, where the disparate symbol(s) are phase-continuous duplicates as described, at least a portion of the symbol can be received in a receiver window without interference. This can facilitate interference free receiving of the symbol by evaluating the extended symbol in multiple receiver windows, as described.

Turning to FIG. 11, illustrated is a methodology 1100 that facilitates receiving symbols without intercarrier interference in wireless communications. At 1102, a symbol can be received over a plurality of receiver windows. For example, the symbol can extend beyond a typical symbol period, and thus beyond a single receiver window. As described, this can result in at least one receiver window having the desired symbol without interference from adjacent symbols or carriers. Thus, at 1104, the at least one window that received the non-interfered symbol can be determined. The determination can be made by evaluating the windows, which can include demodulating the symbol to determine which has the correct CRC, in one example. At 1106, the non-interfered symbol can be adjusted based on a determined timing misalignment. As described, since the receiver windows can be misaligned with respect to the symbols received, the symbol can appear to be multiplied by phase ramps across different tones. The timing misalignment can be determined and corrected, in one example, via estimation and removal of related phase ramping. Subsequently, the non-interfered symbol can be demodulated at 1108.

It will be appreciated that, in accordance with one or more aspects described herein, inferences can be made regarding determining which received signal in one or more receiver windows is non-interfered, as described. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

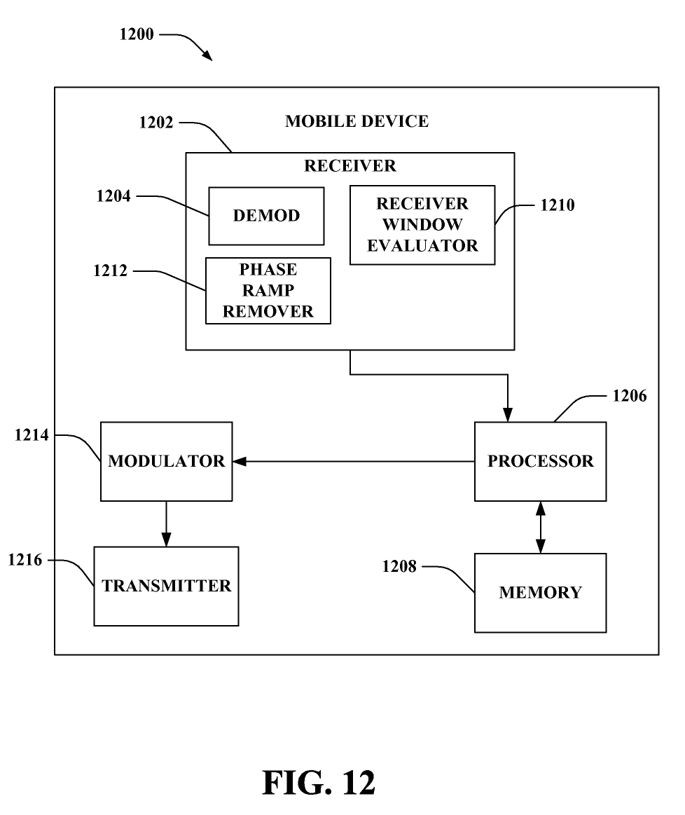

FIG. 12 is an illustration of a mobile device 1200 that facilitates receiving symbols in wireless communication networks mitigating interference from adjacent carriers. Mobile device 1200 comprises a receiver 1202 that receives one or more signals over one or more carriers from, for instance, a receive antenna (not shown), performs typical actions on (e.g., filters, amplifies, downconverts, etc.) the received signals, and digitizes the conditioned signals to obtain samples. Receiver 1202 can comprise a demodulator 1204 that can demodulate received symbols and provide them to a processor 1206 for channel estimation. Processor 1206 can be a processor dedicated to analyzing information received by receiver 1202 and/or generating information for transmission by a transmitter 1216, a processor that controls one or more components of mobile device 1200, and/or a processor that both analyzes information received by receiver 1202, generates information for transmission by transmitter 1216, and controls one or more components of mobile device 1200.

Mobile device 1200 can additionally comprise memory 1208 that is operatively coupled to processor 1206 and that can store data to be transmitted, received data, information related to available channels, data associated with analyzed signal and/or interference strength, information related to an assigned channel, power, rate, or the like, and any other suitable information for estimating a channel and communicating via the channel. Memory 1208 can additionally store protocols and/or algorithms associated with estimating and/or utilizing a channel (e.g., performance based, capacity based, etc.).

It will be appreciated that the data store (e.g., memory 1208) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 1208 of the subject systems and methods is intended to comprise, without being limited to, these and any other suitable types of memory.

Receiver 1202 can further comprise a receiver window evaluator 1210 that can analyze received symbols to determine which are not affected by intercarrier interference, as described, and a phase ramp remover 1212 that can negate phase ramp in a received symbol, as described. According to an example, the receiver can receive a signal comprising an extended length symbol, and the receiver window evaluator 1210 can align multiple receiver windows to receive the symbol. The symbol can be of an extended length, as described, and can be the original symbol transmitted twice phase-continuously in one symbol (e.g., or thrice, etc.). Thus, at least one receiver window, which can be the size of the original symbol, can receive a boundary-less portion of the extended symbol. This portion can exhibit phase ramping properties due to possible time misalignment, and the phase ramp remover 1212 can account for the misalignment by removing phase ramping, as described. The demodulator 1204 can demodulate the symbol to provide data transmitted as part of the symbol. In addition, as described, the extended symbol can be an original symbol followed by a blank symbol. In another example, as described, the receiver window evaluator 1210 can divide the receiver windows in half (or thirds, etc.) to receive the symbol over multiple windows. Mobile device 1200 still further comprises a modulator 1214 and transmitter 1216 that respectively modulate and transmit signals to, for instance, a base station, another mobile device, etc. Although depicted as being separate from the processor 1206, it is to be appreciated that the demodulator 1204 and/or modulator 1214 can be part of the processor 1206 or multiple processors (not shown).

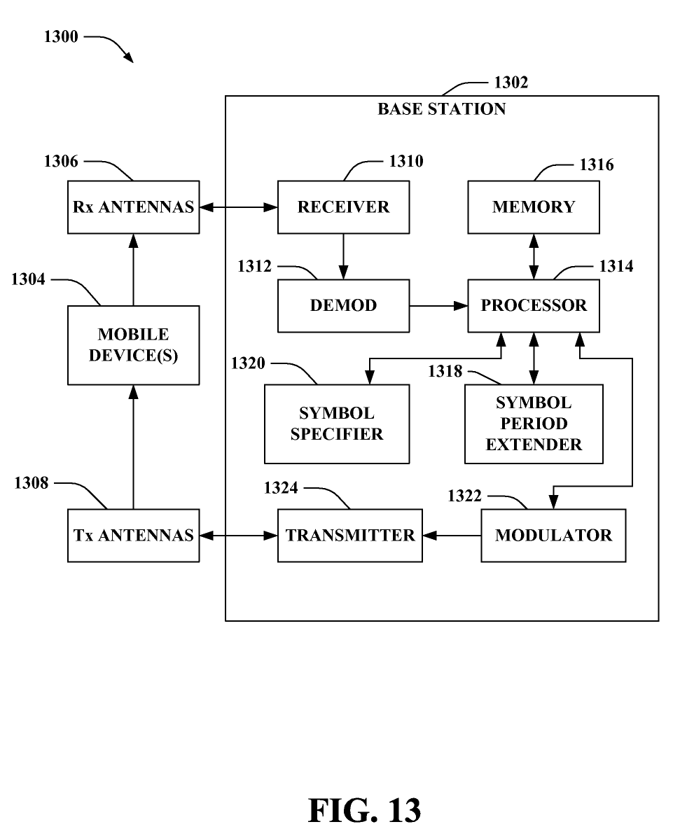

FIG. 13 is an illustration of a system 1300 that facilitates transmitting symbols over extended symbol periods in wireless communication networks. The system 1300 comprises a base station 1302 (e.g., access point, . . . ) with a receiver 1310 that receives signal(s) from one or more mobile devices 1304 through a plurality of receive antennas 1306, and a transmitter 1324 that transmits to the one or more mobile devices 1304 through a plurality of transmit antennas 1308. Receiver 1310 can receive information from receive antennas 1306 and is operatively associated with a demodulator 1312 that demodulates received information. Demodulated symbols are analyzed by a processor 1314 that can be similar to the processor described above with regard to FIG. 9, and which is coupled to a memory 1316 that stores information related to estimating a signal (e.g., pilot) strength and/or interference strength, data to be transmitted to or received from mobile device(s) 1304 (or a disparate base station (not shown)), and/or any other suitable information related to performing the various actions and functions set forth herein. Processor 1314 is further coupled to a symbol period extender 1318 that extends a symbol period by a factor of an original symbol size and a symbol specifier 1320 that populates the extended symbol period with one or more symbols for transmission.

According to an example, the symbol period extender 1318 can lengthen a symbol period for transmitting symbols over a data channel, such as an asynchronous channel as described above. The symbol specifier 1320 can generate a symbol for transmitting over the extended period. As described, the symbol can be an original symbol combined with a copy of the symbol in one phase-continuous extended symbol. In another example, the symbol can be an original symbol combined with a blank symbol in an extended symbol. Furthermore, although depicted as being separate from the processor 1314, it is to be appreciated that the symbol period extender 1318, symbol specifier 1320, demodulator 1312, and/or modulator 1322 can be part of the processor 1014 or multiple processors (not shown).

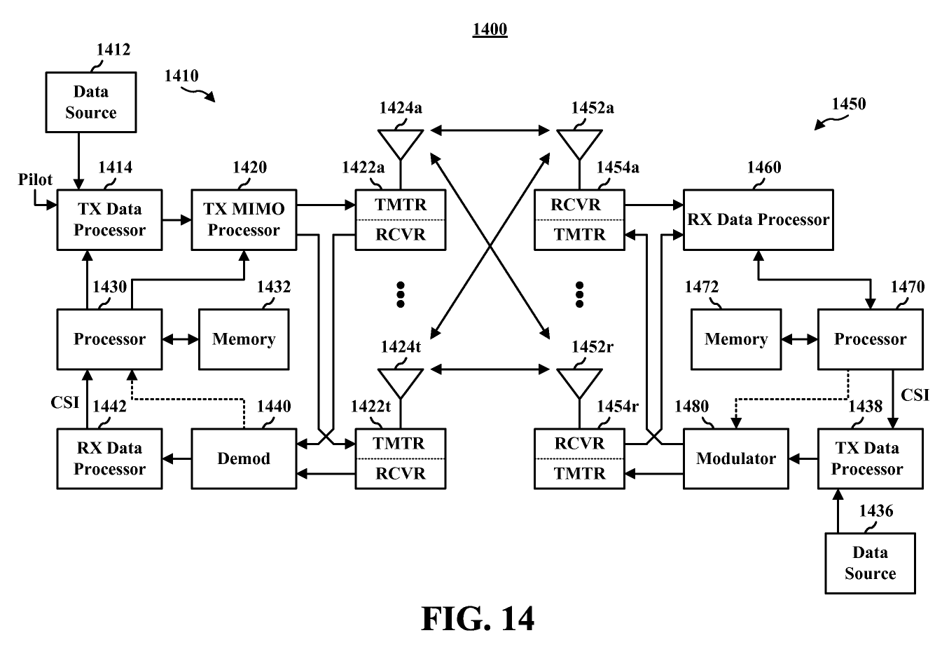

FIG. 14 shows an example wireless communication system 1400. The wireless communication system 1400 depicts one base station 1410 and one mobile device 1450 for sake of brevity. However, it is to be appreciated that system 1400 can include more than one base station and/or more than one mobile device, wherein additional base stations and/or mobile devices can be substantially similar or different from example base station 1410 and mobile device 1450 described below. In addition, it is to be appreciated that base station 1410 and/or mobile device 1450 can employ the systems (FIGS. 1-3 and 12-13), diagram examples (FIGS. 4-9) and/or methods (FIGS. 10-11) described herein to facilitate wireless communication there between.

At base station 1410, traffic data for a number of data streams is provided from a data source 1412 to a transmit (TX) data processor 1414. According to an example, each data stream can be transmitted over a respective antenna. TX data processor 1414 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 1450 to estimate channel response. The multiplexed pilot and coded data for each data stream can be modulated (e.g. symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 1430.

The modulation symbols for the data streams can be provided to a TX MIMO processor 1420, which can further process the modulation symbols (e.g., for OFDM). TX MIMO processor 1420 then provides N_{T} modulation symbol streams to N_{T} transmitters (TMTR) 1422a through 1422t. In various embodiments, TX MIMO processor 1420 applies beamforming weights to the symbols of the data streams and to the antenna from which the symbol is being transmitted.

Each transmitter 1422 receives and processes a respective symbol stream to provide one or more analog signals, and further conditions (e.g. amplifies, filters, and upconverts) the analog signals to provide a modulated signal suitable for transmission over the MIMO channel. Further, N_{T} modulated signals from transmitters 1422a through 1422t are transmitted from N_{T} antennas 1424a through 1424t, respectively.

At mobile device 1450, the transmitted modulated signals are received by N_{R} antennas 1452a through 1452r and the received signal from each antenna 1452 is provided to a respective receiver (RCVR) 1454a through 1454r. Each receiver 1454 conditions (e.g., filters, amplifies, and downconverts) a respective signal, digitizes the conditioned signal to provide samples, and further processes the samples to provide a corresponding “received” symbol stream.

An RX data processor 1460 can receive and process the N_{R} received symbol streams from N_{R} receivers 1454 based on a particular receiver processing technique to provide N_{T} “detected” symbol streams. RX data processor 1460 can demodulate, deinterleave, and decode each detected symbol stream to recover the traffic data for the data stream. The processing by RX data processor 1460 is complementary to that performed by TX MIMO processor 1420 and TX data processor 1414 at base station 1410.

A processor 1470 can periodically determine which precoding matrix to utilize as discussed above. Further, processor 1470 can formulate a reverse link message comprising a matrix index portion and a rank value portion.

The reverse link message can comprise various types of information regarding the communication link and/or the received data stream. The reverse link message can be processed by a TX data processor 1438, which also receives traffic data for a number of data streams from a data source 1436, modulated by a modulator 1480, conditioned by transmitters 1454a through 1454r, and transmitted back to base station 1410.

At base station 1410, the modulated signals from mobile device 1450 are received by antennas 1424, conditioned by receivers 1422, demodulated by a demodulator 1440, and processed by a RX data processor 1442 to extract the reverse link message transmitted by mobile device 1450. Further, processor 1430 can process the extracted message to determine which precoding matrix to use for determining the beamforming weights.

Processors 1430 and 1470 can direct (e.g., control, coordinate, manage, etc.) operation at base station 1410 and mobile device 1450, respectively. Respective processors 1430 and 1470 can be associated with memory 1432 and 1472 that store program codes and data. Processors 1430 and 1470 can also perform computations to derive frequency and impulse response estimates for the uplink and downlink, respectively.

It is to be understood that the embodiments described herein can be implemented in hardware, software, firmware, middleware, microcode, or any combination thereof For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

When the embodiments are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

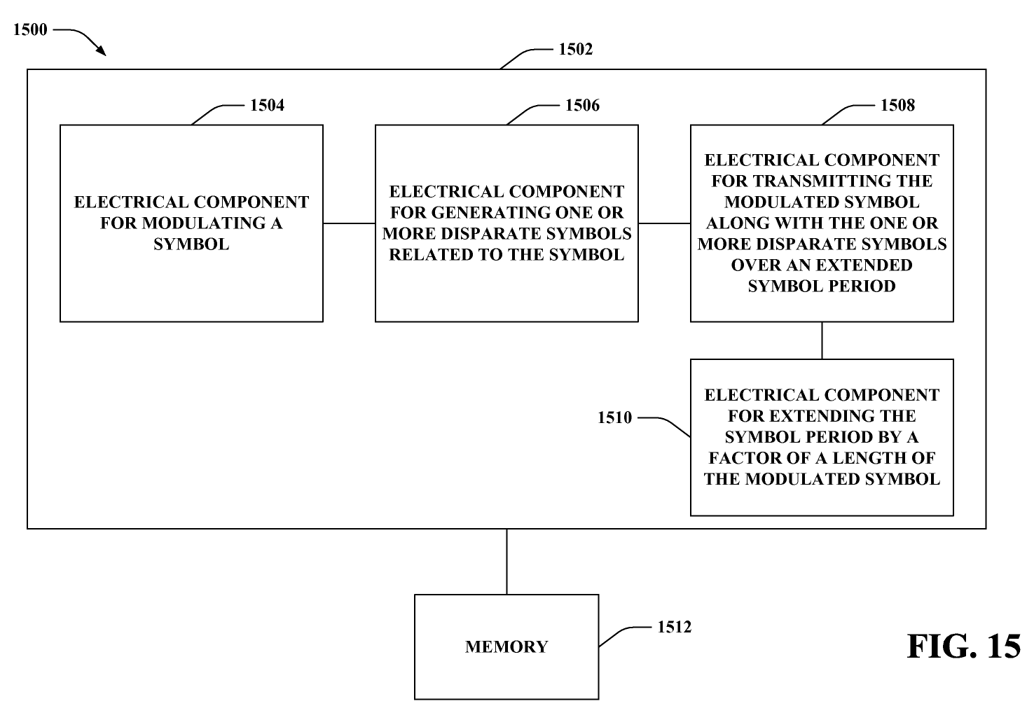

With reference to FIG. 15, illustrated is a system 1500 that transmits symbols over extended symbol periods in wireless communications. For example, system 1500 can reside at least partially within a base station, mobile device, etc. It is to be appreciated that system 1500 is represented as including functional blocks, which can be functional blocks that represent functions implemented by a processor, software, or combination thereof (e.g., firmware). System 1500 includes a logical grouping 1502 of electrical components that can act in conjunction. For instance, logical grouping 1502 can include an electrical component for modulating a symbol 1504. For example, the symbol can also be encoded, as described, using a CRC, error correcting code, and/or the like, in one example. Further, logical grouping 1502 can comprise an electrical component for generating one or more disparate symbols related to the symbol 1506. As shown, the disparate symbol(s) can be phase-continuous duplicates of the symbol, a blank symbol, etc. Thus, the symbols can be generated for transmission over the extended period. As described, the symbols are extended to facilitate mitigating intercarrier interference. In one example, the disparate symbol can be a phase-continuous representation of the original symbol, a blank symbol, and/or the like, as described. Furthermore, logical grouping 1502 can include an electrical component for transmitting the modulated symbol along with the one or more disparate symbols over an extended symbol period 1508. For example, as described, a receiving device can view the symbol over multiple receiver windows such that at least one window receives the symbol without interference, though the symbol can be circularly shifted in time. Also, logical grouping 1502 can include an electrical component for extending the symbol period by a factor of a length of the modulated symbol 1510, as described previously. Additionally, system 1500 can include a memory 1512 that retains instructions for executing functions associated with electrical components 1504, 1506, 1508, and 1510. While shown as being external to memory 1512, it is to be understood that one or more of electrical components 1504, 1506, 1508, and 1510 can exist within memory 1512.

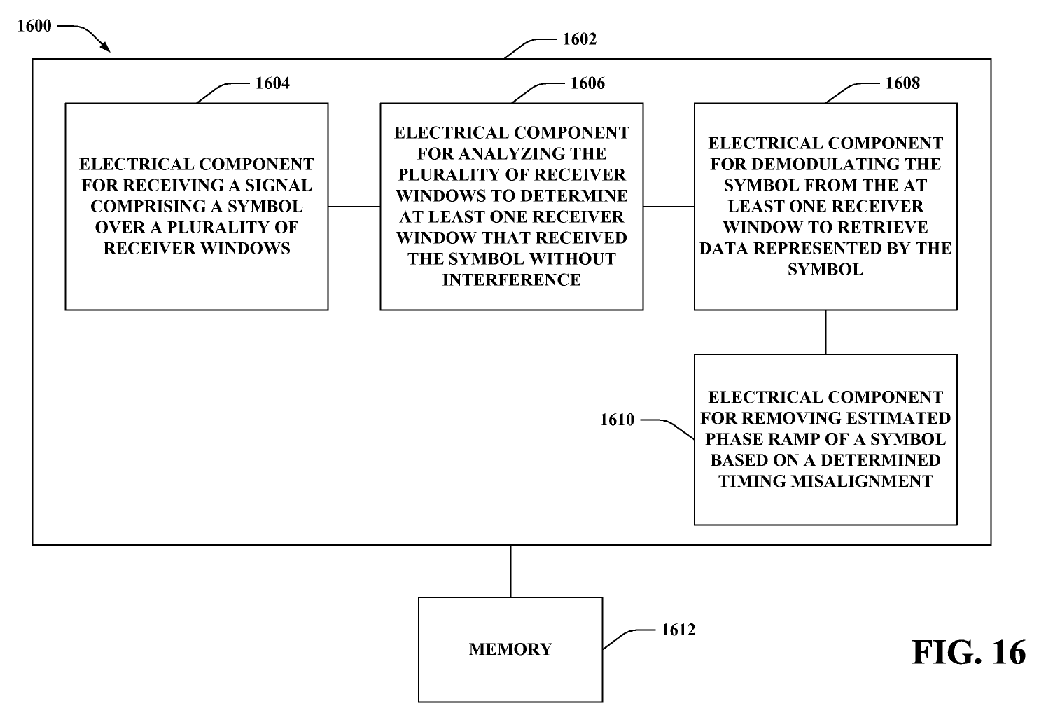

Turning to FIG. 16, illustrated is a system 1600 that receives and demodulates symbols free from intercarrier interference. System 1600 can reside within a base station, mobile device, etc., for instance. As depicted, system 1600 includes functional blocks that can represent functions implemented by a processor, software, or combination thereof (e.g., firmware). System 1600 includes a logical grouping 1602 of electrical components that facilitate receiving the symbols. Logical grouping 1602 can include an electrical component for receiving a signal comprising a symbol over a plurality of receiver windows 1604. The symbol, for example, can be transmitted over an extended symbol period such to require multiple windows to receive the entire symbol. Moreover, logical grouping 1602 can include an electrical component for analyzing the plurality of receiver windows to determine at least one receiver window that received the symbol without interference 1606. For example, this can be accomplished by demodulating received portions to determine which is a valid symbol portion (e.g., which symbol has a correct CRC). In another example, as described, the portions can be added to generate the symbol and a blank symbol. Furthermore, logical grouping 1602 can also include an electrical component for demodulating the symbol from the at least one receiver window to retrieve data represented by the symbol 1608. Also, logical grouping 1602 can include an electrical component for removing estimated phase ramp of a symbol based on a determined timing misalignment, as described. Additionally, system 1600 can include a memory 1612 that retains instructions for executing functions associated with electrical components 1604, 1606, 1608, and 1610. While shown as being external to memory 1612, it is to be understood that electrical components 1604, 1606, 1608, and 1610 can exist within memory 1612.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

What is claimed is:

1. A method for mitigating intercarrier interference in wireless communications, comprising:
generating a modulation symbol;
generating one or more disparate symbols; and
transmitting the modulation symbol along with the one or more disparate symbols in a portion of a communications channel over a symbol period extended by a factor of a length of the modulation symbol.

2. The method of claim 1, wherein the one or more disparate symbols are substantially the same as the modulation symbol and the one or more disparate symbols are phase-continuous with the modulation symbol.

3. The method of claim 1, wherein the one or more disparate symbols are blank symbols.

4. The method of claim 1, wherein the modulation symbol is a pilot symbol.

5. The method of claim 1, further comprising separating the communications channel from other channels in frequency using guard bandwidth.

6. The method of claim 1, wherein the modulation symbol and/or the disparate symbols are encoded symbols using an error correcting code.

7. The method of claim 6, wherein the modulation symbol and/or the disparate symbols are encoded symbols corresponding to a cyclic redundancy check (CRC).

8. The method of claim 1, wherein the portion of the communications channel over the symbol period is restricted to transmitting only the modulation symbol and the one or more disparate symbols.

9. A wireless communications apparatus, comprising:
at least one processor configured to:
receive a modulated symbol for transmission;
receive one or more disparate symbols that are phase-continuous with the modulated symbol; and
transmit the modulated symbol along with the one or more phase-continuous disparate symbols in a communications channel over a symbol period extended by a factor of a length of the modulated symbol; and
a memory coupled to the at least one processor.

10. A wireless communications apparatus that facilitates mitigating intercarrier interference in wireless communications, comprising:
means for modulating a symbol;
means for generating one or more disparate symbols related to the symbol; and
means for transmitting the modulated symbol along with the one or more disparate symbols over an extended symbol period.

11. A computer program product, comprising:
a computer-readable medium comprising:
code for causing at least one computer to generate a modulated symbol;
code for causing the at least one computer to generate one or more disparate symbols to be phase-continuous with the modulated symbol; and
code for causing the at least one computer to transmit the modulated symbol along with the one or more phase-continuous disparate symbols over an extended symbol period.

12. An apparatus, comprising:
a symbol specifier that modulates a symbol along with one or more related disparate symbols; and
a signal generator that transmits the modulated symbol along with the one or more disparate symbols over an extended symbol period.

13. The apparatus of claim 12, further comprising a symbol period extender that extends the symbol period by a factor of a length of the symbol.

14. The apparatus of claim 12, wherein the one or more disparate symbols are substantially the same as the modulated symbol and the symbol specifier generates the one or more disparate symbols to be phase-continuous with the modulated symbol.

15. The apparatus of claim 12, wherein the one or more disparate symbols are blank symbols.

16. The apparatus of claim 12, wherein symbol and/or the disparate symbols are pilot symbols.

17. The apparatus of claim 12, wherein the symbol specifier further encodes the symbol and/or the disparate symbols using an error correcting code.

18. The apparatus of claim 12, wherein the symbol specifier further encodes the symbol and/or the disparate symbols using a cyclic redundancy check (CRC).

19. The apparatus of claim 12, wherein the portion of the communications channel over the symbol period is restricted to transmitting the symbol and the one or more disparate symbols.

20. A method that facilitates mitigating interference from symbols received in wireless communications, comprising:
receiving a signal comprising a symbol over a plurality of receiver windows;
determining at least one of the plurality of receiver windows that received the symbol without intersymbol interference where the receiver windows are unaligned to one or more boundaries of the symbol; and
demodulating the symbol from the at least one receiver window to retrieve data represented by the symbol.

21. The method of claim 20, further comprising:
determining a timing misalignment related to the symbol; and
computing and removing a phase ramp exhibited by the symbol to appropriately align the symbol for demodulation thereof.

22. The method of claim 21, further comprising evaluating a phase variation across a plurality of pilot signals to determine the timing misalignment.

23. The method of claim 20, wherein the symbol comprises multiple contiguous phase-continuous representations of a single symbol that represents the data transmitted over an extended symbol period.

24. The method of claim 20, wherein the symbol comprises a single symbol that represents the data and a blank symbol transmitted contiguously over an extended symbol period.

25. The method of claim 20, further comprising dividing one or more existing receiver windows to generate the plurality of receiver windows over which the symbol is received.

26. The method of claim 20, wherein determining the at least one of the plurality of receiver windows that received the symbol without interference includes demodulating the symbol received at each receiver window to determine which symbol has a correct cyclic redundancy check.

27. The method of claim 20, further comprising receiving a signal from a disparate sector comprising a symbol over a plurality of receiver windows where the windows are unaligned to the symbol.

28. A wireless communications apparatus, comprising:
at least one processor configured to:
receive a signal comprising a symbol over a plurality of receiver windows;
analyze the plurality of receiver windows to determine at least one receiver window that received the symbol without intersymbol interference; and
demodulate the symbol from the at least one receiver window to retrieve data represented by the symbol; and
a memory coupled to the at least one processor.

29. A wireless communications apparatus for mitigating intersymbol interference in communicating over asynchronous channels, comprising:
means for receiving a signal comprising a symbol over a plurality of receiver windows;
means for analyzing the plurality of receiver windows to determine at least one receiver window that received the symbol without intersymbol interference; and
means for demodulating the symbol from the at least one receiver window to retrieve data represented by the symbol.

30. A computer program product, comprising:
a computer-readable medium comprising:
code for causing at least one computer to receive a signal comprising a symbol over a plurality of receiver windows;
code for causing the at least one computer to determine at least one of the plurality of receiver windows that received the symbol; and
code for causing the at least one computer to demodulate the symbol from the at least one receiver window to retrieve data represented by the symbol.

31. An apparatus, comprising:
a receiver that receives a signal comprising a symbol over a plurality of receiver windows;
a receiver window evaluator that analyzes the plurality of receiver windows to determine at least one receiver window that received the symbol; and
a symbol demodulator that demodulates the symbol from the at least one receiver window to retrieve data represented by the symbol.

32. The apparatus of claim 31, further comprising a phase ramp remover that estimates and removes a phase ramp of the symbol based at least in part on a determined timing misalignment.

33. The apparatus of claim 32, wherein the phase ramp remover evaluates a phase variation across a plurality of pilot signals to determine the timing misalignment.

34. The apparatus of claim 31, wherein the symbol comprises multiple contiguous phase-continuous representations of a single symbol that represents the data transmitted over an extended symbol period.

35. The apparatus of claim 31, wherein the symbol comprises a single symbol that represents the data and a blank symbol transmitted contiguously over an extended symbol period.

36. The apparatus of claim 31, wherein the receiver window evaluator divides one or more existing receiver windows to generate the plurality of receiver windows over which the symbol is received.

37. The apparatus of claim 31, wherein the receiver window evaluator determines the at least one of the plurality of receiver windows that received the symbol without interference based at least in part on demodulating the symbol received at each receiver window to determine which symbol has a correct cyclic redundancy check.
